(19) United States
(12) Patent Application Publication
(10) Pub. No.: US 2004/0266460 A1
(43) Pub. Date: Dec. 30, 2004

(54) System and method for interacting with a shared electronic display

(75) Inventor: Franklin Reynolds, Bedford, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/606,291

(22) Filed: Jun. 25, 2003

(51) Int. Cl. H04Q 7/20

(52) U.S. Cl. 455/457; 455/456.3; 455/456.6

(57) ABSTRACT

According to one aspect of the present invention, a system is provided for interacting with a shared electronic display. The system includes at least one mobile station and a processor. The mobile stations are capable of storing a personal profile of a user of the respective mobile station. The processor, then, can generate a position indicator based upon each personal profile of the mobile stations. Thereafter, the processor is capable of driving the electronic display to present information and each position indicator. The processor can also communicate with the mobile stations such that each mobile station is capable of directing a position of the respective position indicator presented on the electronic display.

### FIELD OF THE INVENTION

The present invention generally relates to systems and methods of interacting with public electronic displays and, more particularly, relates to systems and methods of interacting with shared, typically public, electronic displays capable of interacting with a plurality of users.

### BACKGROUND OF THE INVENTION

Interactive, public, shared displays are a new type of product. The basic technology of traditional public displays, such as signs or billboards, has not significantly changed in hundreds of years. In the last several years, the development of electronic displays has allowed for the creation of dynamic content. The traditional mode of user interaction, however, has remained largely unchanged. In this regard, public displays have traditionally been a one way media. The creator or publisher of the display controls what information is presented, and consumers can receive the information or ignore it. However, consumers have traditionally not been capable of controlling or interacting with the information presented by the displays. Even the advent of large, electronic displays, such as the departure and arrival signs at airports, has not changed this basic mode of operation.

Technology has been developed that facilitates user interactivity with public displays (keyboards, touch screens, IR remote controls, etc.). However, the sharing of a single display among multiple users creates a significant usability problem. Consider the simple case of a television in a public bar with multiple viewers—who decides which channel to watch or controls the volume? More sophisticated applications make the usability problem even more challenging. For example, the designers of digital media kiosks usually find the problem of sharing a public display overwhelming and resort to one-at-a-time user consoles. This “one-at-a-time” usage model is a workable strategy for some applications, but such a model allows only a very limited amount of “sharing.”

### SUMMARY OF THE INVENTION

In light of the foregoing background, embodiments of the present invention provide systems and methods of interacting with shared electronic displays. One of the most common ways for users to interact with computing systems is via a position indicator, such as a cursor, controlled by a peripheral, such as a mouse. The idea of a cursor that can be controlled by the user is almost universally accepted as part of the graphical user interface (GUI) of many computing systems. In contrast to conventional computing systems where only one position indicator can be utilized at a single time, embodiments of the present invention are capable of supporting a plurality of position indicators, where each position indicator is associated with a particular user, or more particularly a user device. To distinguish the position indicator of one user from the next, then, the position indicators are generated based upon a personal profile, such as to generate position indicators unique to particular users.

According to one aspect of the present invention, a system is provided for interacting with a shared electronic display. The system includes at least one mobile station and a processor. The mobile stations are capable of storing a personal profile of a user of the respective mobile station. The processor, then, can generate a position indicator based upon each personal profile of the mobile stations. The system can also include a communications interface in electrical communication with the mobile stations and the processor. In this regard, the communications interface can communicate with each of the mobile stations to thereby receive the personal profile of the respective mobile station. The communications interface can then deliver the personal profile of each of the mobile stations to the processor. After generating the position indicators, the processor can drive the electronic display to present information and each position indicator. In addition, the processor can be capable of driving the electronic display to further present at least one selectable object. The processor can also communicate with the mobile stations such that each mobile station is capable of directing a position of the respective position indicator presented on the electronic display.

The processor can also be capable of transmitting information to and/or receiving information from the mobile stations. More particularly, the mobile stations can direct the position of the respective position indicators to thereby select at least one selectable object presented by the electronic display. The processor can then be capable of transmitting information to and receiving information from at least one mobile station when the respective mobile stations select at least one selectable object. The processor can also be capable of modifying at least a portion of the information presented by the electronic display in response to transmitting information to and receiving information from at least one mobile station. Additionally, or alternatively, the processor can be capable of the modifying at least one position indicator to indicate an operational mode of the respective position indicator.

The system can also include a resource in electrical communication with the processor. In such embodiments, the resource can store the personal profile of the user of at least one respective mobile station. In this regard, at least one mobile station is capable of storing a uniform resource indicator (URI) of the resource. The processor can then be capable of communicating with the resource based upon the URI to thereby retrieve the personal profile of the user of at least one mobile station before generating the position indicator based upon the respective personal profile.

A shared display system and method of interacting with a shared electronic display are also provided. Embodiments of the present invention therefore provide systems and methods of interacting with shared electronic displays that, in contrast to conventional computing systems, permit multiple users to concurrently interact with electronic displays. In this regard, in contrast to conventional computing systems where only one position indicator can be utilized at a single time, embodiments of the present invention are capable of supporting a plurality of position indicators, where each position indicator is associated with a particular user, or more particularly a user device. To distinguish the position indicator of one user from the next, then, the position indicators are generated based upon a personal profile, such as to generate position indicators unique to particular users. As such, the systems and methods of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for interacting with a shared electronic display according to one embodiment of the present invention;

FIG. 2 is a schematic block diagram of a mobile station according to one embodiment of the present invention; and

FIG. 3 is a schematic illustration of one scenario of the implementation of the system and method of one embodiment of the present invention including a theater with a shared, public electronic display, and a mobile telephone and PDA.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

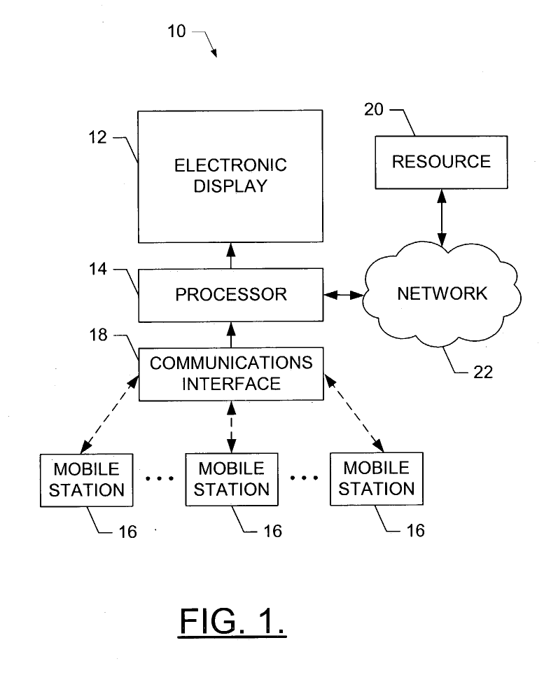

Referring to FIG. 1, according to one aspect of the present invention, a system 10 is provided for interacting with a shared electronic display 12. The system includes a processor 14 that is in electrical communication with the electronic display. The system also includes at least one mobile station 16 in electrical communication with the processor, such as via a communications interface 18. In addition, the system can include a resource 20 in electrical communication with the processor, such as via a network 22. In this regard, the network can comprise any of a number of different types of networks, such as a local area network (LAN), a metropolitan area network (MAN) or a wide area network (WAN) like the Internet.

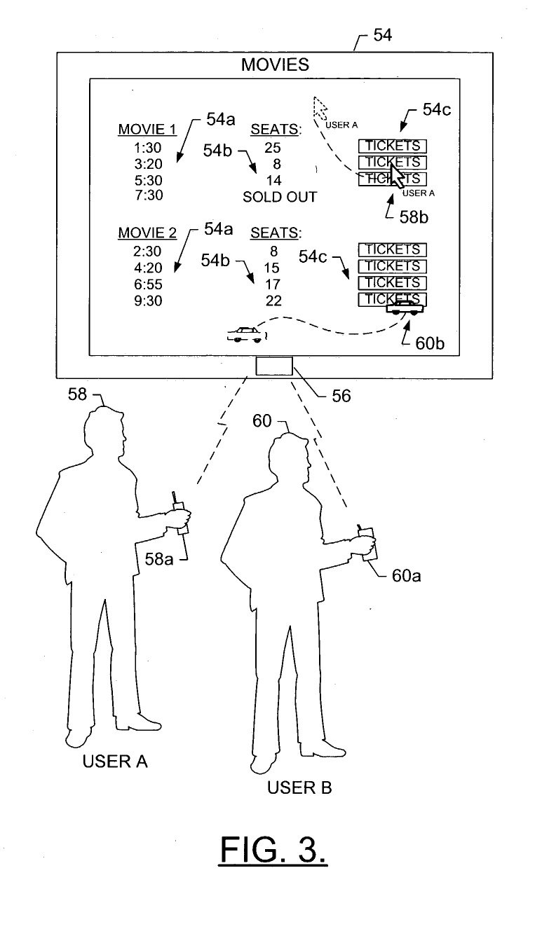

The electronic display 12 can comprise any of a number of known electronic displays capable of operating according to embodiments of the present invention. For example, the electronic display can comprise a cathode ray tube (CRT), plasma display or the like. The processor 14 can comprise any of a number of known processing devices, such as a personal computer, server computer or other high level processor. In accordance with embodiments of the present invention, the processor is capable of driving the electronic display to present information, such as graphical information, textual information or the like. The information typically comprises information applicable to one or, more particularly, a plurality of users. For example, the information may comprise schedule information, such as a public transportation schedule or a movie schedule (see FIG. 3). Also, for example, the information may comprise map and/or direction information. Further, for example, the information may comprise game information, such as relating to an electronic board game or a multiplayer game.

In addition to the information, the electronic display 12 is capable of presenting one or more selectable objects, such as hypertext links, capable of initiating the transfer of information to and/or from the processor 14. As described below, in accordance with embodiments of the present invention, the electronic display is further capable of presenting one or, more typically, a plurality of position indicators, such as cursors or the like, associated with a personal profile of a user. As used herein, then, such position indicators will be referred to as personal cursors. In this regard, the personal cursors allow users to navigate the electronic display, such as to select one or more of the selectable objects, to thereby interact with the electronic display.

The communications interface 18 can comprise any of a number of devices, systems or the like capable of transmitting and/or receiving information, such as to and/or from the mobile stations 16. For example, the communications interface can comprise an infrared transceiver, radio frequency (RF) transceiver and/or a Bluetooth transceiver capable of transmitting and/or receiving information via infrared, RF and/or Bluetooth transfer techniques, respectively. Also, for example, the communications interface can comprise a wireless access point capable of transmitting and/or receiving information via a number of different techniques, including Wireless Local Area Network (WLAN) techniques such as IEEE 802.11 techniques or the like.

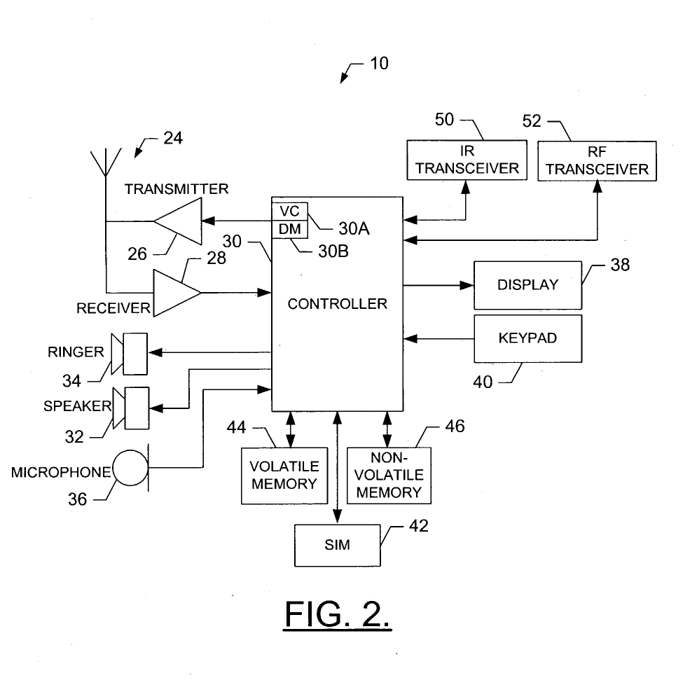

Reference is now made to FIG. 2, which illustrates one type of terminal, such as a mobile station 16, that would benefit from the present invention. It should be understood, however, that the mobile telephone illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, and other types of electronic communications systems, can readily employ the present invention.

In addition, while several embodiments of the system and method of the present invention include a terminal comprising a mobile station, the terminal need not comprise a mobile station. In this regard, the terminal can comprise any of a number of other mobile processing devices, such as a laptop computer or the like, capable of operating according to embodiments of the present invention. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

As shown, the mobile station 16 includes an antenna 24 for transmitting and receiving signals, such as to and from a base site or base station. The mobile station also includes a transmitter 26, a receiver 28, and a controller 30 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first, second and/or third-generation communication protocols or the like. For example, the mobile station may be capable of operating in accordance with second-generation (2G) wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station 16. For example, the controller may be comprised of a digital signal processor device, a microprocessor device, and various analog-to-digital converters, digital-to-analog converters, and other support circuits. The control and signal processing functions of the mobile station are allocated between these devices according to their respective capabilities. The controller can additionally include an internal voice coder (VC) 30A, and may include an internal data modem (DM) 30B. Further, the controller 30 may include the functionally to operate one or more software programs, which may be stored in memory (described below). For example, the controller may be capable of operating a connectivity program, such as a conventional Web browser. The connectivity program may then allow the mobile station to transmit and receive Web content, such as according to the Hypertext Transfer Protocol (HTTP) and/or the Wireless Application Protocol (WAP), for example.

The mobile station 16 also comprises a user interface including a conventional earphone or speaker 32, a ringer 34, a microphone 36, a display 38, and a user input interface, all of which are coupled to the controller 50. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

The mobile station 16 can also include memory, such as a subscriber identity module (SIM) 42, a removable user identity module (R-UIM) or the like, which typically stores information elements related to a mobile subscriber. In addition to the SIM, the mobile station can include other removable and/or fixed memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. In this regard, the memories can store a personal profile capable of uniquely identifying a user of the mobile station, and more particularly the mobile station itself, such as to the processor 14. For example, the personal profile can include any of a number of different pieces of information, such as an international mobile equipment identification (IMEI) code capable of uniquely identifying the mobile station, and/or a textual phrase (e.g., username), graphic (e.g., graphical icon) or other identifier understood by the user of the mobile station as identifying the respective user. In addition to, or in lieu of, storing the personal profile, the memories can store a uniform resource identifier (URI) of a resource 20, which may provide all or a portion of the personal profile.

The mobile station can further include an infrared transceiver 50 or another local data transfer device so that data can be shared with and/or obtained from the communications interface 18, as well as from other devices such as other mobile stations, car guidance systems, personal computers and printers, if so desired. The sharing of data, as well as the remote sharing of data, can also be provided according to a number of different techniques. For example, the mobile station may additionally, or alternatively, include a radio frequency transceiver 52 capable of sharing data with other radio frequency transceivers, and/or with a Radio Frequency Identification (RFID) transponder tag, as such is known to those skilled in the art. Additionally, or alternatively, the mobile station may share data using Bluetooth brand wireless technology developed by the Bluetooth Special Interest Group. Further, the mobile station may be capable of transmitting and receiving data according to a number of different wireless networking techniques, including WLAN techniques such as IEEE 802.11 techniques or the like.

Referring back to FIG. 1, in accordance with embodiments of the present invention, a mobile station 16 is capable of interacting with electronic display 12, where the processor 14 drives the electronic display to present information, and typically at least one selectable object. The mobile station can interact with the electronic display by first transmitting the personal profile of the user of the mobile station to the processor, such as via communications interface 18. Additionally, or alternatively, the mobile station can transmit the URI of a resource 20 to the processor. The mobile station can transfer the personal profile and/or URI in any of a number of different manners, such as via infrared, radio frequency, Bluetooth and/or WLAN transfer techniques.

Upon receiving the personal profile from the mobile station 10, the processor 14 is capable of generating a personal cursor based upon the personal profile. In embodiments where the mobile station transmits the URI of the resource 20 to the processor, the processor can communicate with the resource based upon the URI, such as via the Network 22, to thereby retrieve all or a portion of the personal profile. Thereafter, the processor can generate the personal cursor based upon the personal profile. The processor can generate the personal cursor in any of a number of different manners, such as by generating a position indicator, such as a cursor, and appending the textual phrase in the personal profile that identifies the respective user. Additionally, or alternatively, for example, the processor can generate the personal cursor by generating a position indicator comprising the graphic in the personal profile that identifies the respective user. In either event, the personal cursor generated by the processor is uniquely associated with the respective mobile station, such as by associating the personal cursor with the IMEI code of the mobile station included in the personal profile.

After generating the personal cursor, the processor 14 is capable of driving the electronic display 12 to present the personal cursor, typically by overlaying the personal cursor over the information and/or selectable objects presented by the electronic display. Thereafter, the mobile station 16 is capable of communicating with the processor, such as via the communications interface 18, to thereby direct the position of the personal cursor. The mobile station can communicate with the processor to direct the position of the personal cursor according to any of a number of different techniques, such as by utilizing the user interface of the mobile station. Functionally, then, the mobile station may operate as a remote mouse or other pointing device capable of moving the personal cursor about the electronic display. The processor is capable of driving the display to present personal cursors for a plurality of mobile stations. Thus, the processor is capable of communicating with the mobile station and of associating communications to and/or from the mobile station with the personal cursor.

Either before, after or as the mobile station 16 directs the position of the personal cursor, the processor 14 can transmit information to, and receive information from, the mobile station. For example, the mobile station can receive and present on the display 38 of the mobile station, the same information presented by the electronic display 12, including the personal cursor of the mobile station. In this manner, the user of the mobile station can view the display and the personal cursor on the mobile station as the mobile station, or more particularly the user of the mobile station, directs the position of the personal cursor presented by the electronic display, as well as the display of the mobile station.

Also, for example, the mobile station 16 can direct the position of the personal cursor to thereby select one of the selectable objects presented by the electronic display 12. In response to selecting one of the selectable objects, then, the processor 14 can transmit information, such as information related to the selectable object, to the mobile station. For example, presume that the electronic display presents public transportation information, such as a number of bus lines operating from a bus terminal. Also presume that the electronic display includes a number of hyperlinks (i.e., selectable objects) to schedule information for the respective bus lines. In such a scenario, for example, the mobile station can direct the position of the personal cursor to select a hyperlink for a particular bus line. In response to selection of the hyperlink, the processor can transmit the schedule information for the respective bus line to the mobile station, such as for subsequent display by the mobile station.

In addition to driving the electronic display 12 to present information and the personal cursors, the processor 14 can modify all or a portion of the information presented by the electronic display, such as by adding to the information, and/or deleting and/or changing all or a portion of the information. In one typical embodiment, the processor can modify the information presented by the electronic display in response to transmitting information to, and/or receiving information from, the mobile station 16. For example, presume that the information presented by the electronic display comprises an electronic board game. In such an instance, the processor can modify the electronic board game display in response to receiving information from one or more mobile stations, such as information transmitted by the mobile stations during play of the electronic board game. However, the processor need not modify the electronic display in response to interaction with the mobile station and, may instead, continue to present the same information upon the electronic display while providing additional information on the display of the mobile station.

In addition to, or in lieu of, modifying all or a portion of the information presented by the electronic display 12, the processor 14 may be capable of modifying one or more personal cursors, such as to indicate the current operational mode of the personal cursor. For example, as the processor transmits and/or receives information to the mobile station 16, the processor can modify the personal cursor to reflect the information transfer, such as by changing the textual phrase of the personal cursor (e.g., changing the textual phrase to “Transferring” or “Receiving”) and/or the graphic of the personal cursor (e.g., changing the graphic to an up arrow representing an upload or a down arrow representing a download). The textual phrase and/or graphic can be changed into any of a number of different textual phrases and/or graphics recognizable by the user of the mobile station. In this regard, one or more textual phrases and/or graphics can be included within the personal profile of the user such that the user may more readily recognize the textual phrases and/or graphics, and the meaning behind such textual phrases and/or graphics.

The user of the mobile station 16 can conclude interaction with the electronic display 12 at any time after beginning interaction with the electronic display by transmitting the personal profile and/or URI to the processor 14. The mobile station can conclude the interaction in any of a number of different manners. For example, the mobile station can actively conclude the interaction, such as by the user directing the mobile station to cease communicating with the processor. Additionally, or alternatively, when the mobile station communicates with the mobile station according to a geographically limited technique, such as infrared, radio frequency, Bluetooth, and/or WLAN the mobile station can passively conclude the interaction by moving outside of the geographic range of the respective communication technique.

As will be appreciated, in some instances, a user may inadvertently move the mobile station 16 outside the graphic range of the respective communication technique. In such an instance, the processor 14 can modify the personal cursor displayed by the electronic display 12 to represent a lack of communication with the mobile station, such as by changing the textual phrase of the personal cursor (e.g., changing the textual phrase to “Link Lost”) and/or the graphic of the personal cursor (e.g., changing the graphic to a representation of a hearing aid). The processor can then hold the personal cursor on the electronic display for a period of time to afford the user of the mobile station an amount of time to bring the mobile station back into the required graphic range. Then, after the period of time, the processor can remove the personal cursor from the electronic display if communication with the mobile station has not been restored.

Referring now to FIG. 3, one typical scenario is presented that illustrates operation of embodiments of the present invention. As shown in FIG. 3, the electronic display comprises a movie schedule 54 that includes a number of movies, along with corresponding viewing times 54a and number of available seats 54b for each respective viewing. In addition, the movie schedule includes a number of selectable objects, each comprising a selectable icon “Tickets” 54c for purchasing one or more tickets for a respective viewing of a respective movie. Disposed on a border of the movie schedule or otherwise associated with the electronic display, a communications interface comprising a radio frequency transceiver 56 is capable of transmitting information to, and receiving information from, one or more mobile stations. Although described below as being included within the system of the embodiment shown in FIG. 3, the processor is not shown in FIG. 3 for purposes of clarity, and as such, should not be taken to limit the scope of the present invention in any manner.

Presume that user A 58 and user B 60 approach the movie schedule 54. Users A and B both desire to interact with the movie time schedule and, in accordance with embodiments of the present invention, user A is carrying a mobile station comprising a mobile telephone 58a, and user B is carrying a mobile station comprising a PDA 60a. The mobile station and the PDA store the personal profiles of users A and B, respectively. User A has designated, and the personal profile for user A reflects, the textual phrase “User A” to identify user A's personal cursor. User B, on the other hand, enjoys cars and, as such, has designated a graphic of a car to identify user B's personal cursor, where the graphic is included in user B's personal profile.

In operation, then, users A and B 58, 60 initiate interaction with the movie schedule, such as in a manner described above, by transmitting their respective personal profiles to the processor via the radio frequency transceiver. As described herein, users A and B concurrently interact with the movie schedule 54. It will be appreciated, however, that users A and B, as well as any other users, need not concurrently interact with the movie schedule, but instead can interact with the movie schedule in a concurrent, alternating and/or overlapping manner without departing from the spirit and scope of the present invention. Upon receipt of the personal profiles, the processor generates a personal cursor 58b for user A, and a personal cursor 60b for user B, both of which are thereafter presented on the movie schedule. As shown in FIG. 3, and consistent with the respective personal profiles, user A's personal cursor comprises the textual phrase “User A” appended to a generic cursor arrow. In contrast, user B's personal cursor comprises a graphic of a car, consistent with user B's personal profile.

Once the processor has directed the movie schedule 54 to present the personal cursors 58b and 60b, users A and B 58, 60 can direct a position of the respective personal cursors by operating the mobile telephone 58a and PDA 60a, respectively, such as in a manner described above. In this regard, users A and B can direct the mobile telephone and PDA, respectively, to move the respective personal cursors about the movie schedule, which is shown by dashed lines in FIG. 3. Looking over the movie schedule, user A decides to purchase a ticket for the 3:20 viewing of Movie 1, while user B decides to purchase a ticket for the 9:30 viewing of Movie 2. To purchase the tickets, the users can move the respective personal cursors to the selectable icons 54c for the respective viewings of the respective movies, as shown. Using the mobile telephone and PDA, the users can then select the respective selectable icons to initiate purchasing the tickets. The mobile telephone and PDA communicate with the processor to purchase the tickets, such as in accordance with any of a number of known methods for electronically purchasing tickets to events.

After the users have purchased the respective tickets, the processor transmits electronic tickets to the mobile telephone 58a and PDA 60a in accordance with the respective ticket purchases such that the users can subsequently use the electronic tickets for admission to the respective movies. In response to the transfer of the electronic tickets, then, the processor can modify the movie schedule 54 to decrement the available seats by the number of tickets purchased for each respective viewing. For example, presume that user A 58 purchased one ticket for the 3:20 viewing of Movie 1, and user B 60 purchased one ticket for the 9:30 viewing of Movie 2. The processor can therefore decrement the number of available seats for the 3:20 viewing of Movie 1 from eight to seven. Likewise, the processor can decrement the number of available seats for the 9:30 viewing of Movie 2 from twenty-two to twenty-one. As such, the movie schedule can maintain an up-to-date count of the number of available seats for the respective viewings of the movies.

Many modifications and other embodiments of the invention will come to mind to one skilled in the art to which this invention pertains having the benefit of the teachings presented in the foregoing descriptions and the associated drawings. For example, in the above-described scenario involving an electronic display presenting a movie schedule, the electronic display could also have displayed a selectable icon associated with each movie entitled “Preview.” In such an instance, selection of the “Preview” icon can cause a video clip to be either downloaded to the mobile station for viewing or displayed on the electronic display, such as in the background or in an inset. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for interacting with a shared electronic display, the system comprising:
at least one mobile station, wherein each mobile station is capable of storing a personal profile of a user of the respective mobile station; and
a processor capable of generating a position indicator based upon the respective personal profile of the at least one mobile station, wherein the processor is capable of driving the electronic display to present information and the position indicator of the at least one mobile station, and wherein the processor is capable of communicating with the at least one mobile station such that each mobile station is capable of directing a position of the respective position indicator presented on the electronic display.

2. A system according to claim 1, wherein the processor is capable of at least one of transmitting information to and receiving information from the at least one mobile station.

3. A system according to claim 2, wherein the processor is capable of driving the electronic display to further present at least one selectable object, wherein each mobile station is capable of directing a position of the respective position indicator to thereby select at least one selectable object, and wherein the processor is capable of at least one of transmitting information to and receiving information from at least one mobile station when the respective at least one mobile station selects at least one selectable object.

4. A system according to claim 2, wherein the processor is capable of modifying at least a portion of the information presented by the electronic display in response to at least one of transmitting information to and receiving information from at least one mobile station.

5. A system according to claim 1, wherein the processor is capable of modifying at least one position indicator to indicate an operational mode of the respective at least one position indicator.

6. A system according to claim 1 further comprising:
a resource in electrical communication with the processor, wherein the resource is capable of storing the personal profile of the user of at least one respective mobile station, wherein at least one mobile station is capable of storing a uniform resource indicator (URI) of the resource, and wherein the processor is capable of communicating with the resource based upon the URI to thereby retrieve each personal profile before generating the position indicator for the respective at least one mobile station based upon the respective personal profile.

7. A method of interacting with a shared electronic display, the method comprising:
receiving a personal profile of at least one user;
generating a position indicator for each user based upon the personal profile of the at least one user;
driving the electronic display to present information and each position indicator; and
directing a position of each position indicator presented on the electronic display.

8. A method according to claim 7, wherein receiving a personal profile comprises receiving a personal profile from at least one mobile station, and wherein the method further comprises at least one of transmitting information to and receiving information from at least one mobile station after driving the electronic display to present the information and each position indicator.

9. A method according to claim 8, wherein driving the electronic display comprises driving the electronic display to further present at least one selectable object, wherein directing a position of the respective position indicator comprises directing a position of at least one position indicator to thereby select at least one selectable object, and wherein at least one of transmitting information to and receiving information from at least one mobile station comprises at least one of transmitting information to and receiving information from at least one mobile station when the at least one selectable object is selected.

10. A method according to claim 8 further comprising:
modifying at least a portion of the information presented by the electronic display in response to at least one of transmitting information to and receiving information from at least one mobile station.

11. A method according to claim 7 further comprising:
modifying at least one position indicator to indicate an operational mode of the respective at least one position indicator.

12. A method according to claim 7 further comprising:
receiving a uniform resource indicator (URI) of a resource, wherein receiving a personal profile of at least one user comprises receiving the personal profile of at least one user from the resource based upon the URI.

13. A shared display system comprising:
an electronic display; and
a processor capable of receiving a personal profile of at least one user, and thereafter generating a position indicator based upon each personal profile, wherein the processor is capable of driving the electronic display to present information and each position indicator, and wherein the processor is capable of communicating with the at least one user and for receiving instructions from each user regarding a position of the respective position indicator presented on the electronic display.

14. A system according to claim 13, wherein the processor is capable of at least one of transmitting information to and receiving information from at least one mobile station.

15. A system according to claim 14, wherein each mobile station is associated with one of the at least one user, wherein the processor is capable of driving the electronic display to further present at least one selectable object, wherein the processor is responsive to instructions from each user regarding selection of at least one selectable object based upon the position of the respective position indicator, and wherein the processor is capable of at least one of transmitting information to and receiving information from at least one mobile station when the respective a respective user selects at least one selectable object.

16. A system according to claim 14, wherein the processor is capable of modifying at least a portion of the information presented by the electronic display in response to at least one of transmitting information to and receiving information from at least one mobile station.

17. A system according to claim 13, wherein the processor is capable of modifying at least one position indicator to indicate an operational mode of the respective at least one position indicator.

18. A system according to claim 13 further comprising:
a resource in electrical communication with the processor, wherein the resource is capable of storing the personal profile of at least one user, and wherein the processor is capable of receiving a uniform resource indicator (URI) of the resource, and thereafter communicating with the resource based upon the URI to thereby retrieve the personal profile of the at least one user before generating the position indicator for the respective at least one user based upon the respective personal profile.

19. A mobile station comprising:
a memory capable of storing a representation of a personal profile; and
a controller capable of transmitting the representation of the personal profile such that a position indicator can be generated based upon the representation of the personal profile, and thereafter presented on an electronic display along with information, wherein the processor is capable of transmitting instructions to thereby direct a position of the position indicator presented on the electronic display.

20. A mobile station according to claim 19, wherein the controller is capable of communicating with a communications interface to thereby transmit the representation of the personal profile and instructions to the communications interface such that the communications interface can deliver the representation of the personal profile and instructions to a processor capable of controlling the electronic display.

21. A mobile station according to claim 19, wherein the controller is capable of at least one of transmitting and receiving information.

22. A mobile station according to claim 21, wherein the controller is capable of directing a position of the respective position indicator to thereby select at least one selectable object presented on the electronic display, and wherein the controller is capable of at least one of transmitting and receiving information when the controller selects the at least one selectable object.

23. A mobile station according to claim 21, wherein the at least a portion of the information presented by the electronic display is capable of being modified in response to the controller at least one of transmitting and receiving information.
